(19) United States
(12) Patent Application Publication
(10) Pub. No.: US 2009/0043147 A1
(43) Pub. Date: Feb. 12, 2009

(54) Making a Solid Material from an Alkaline Hydroxide

(76) Inventor: Philippe Pichat, Paris (FR)

Correspondence Address: STITES & HARBISON PLLC, 1199 NORTH FAIRFAX STREET, SUITE 900, ALEXANDRIA, VA, 22314, US

(21) Appl. No.: 11/816,734

(22) PCT Filed: Feb. 21, 2006
(86) PCT No.: PCT/FR06/00392

§ 371 Date: Aug. 21, 2007

(30) Foreign Application Priority Data
Feb. 21, 2005 (FR) 0501734
Apr. 5, 2005 (FR) 0503373

(51) Int. Cl. C04B 18/04

(52) U.S. Cl. 588/257

(57) ABSTRACT

The invention concerns a method for making a solid material from an alkaline metal hydroxide or one of its precursors, including mixing the alkaline hydroxide or one of its precursors with a calcium compound and silicon oxide in the presence of water. The invention also concerns a method for storing waste, the solid material being obtainable by said method as well as the use of said material.

The protection of the environment by prevention of water, air and soil pollution constitutes a growing preoccupation. Many wastes particularly industrial wastes contain alkali metal compounds such as sodium, potassium, lithium in considerable quantities, this is the case for example in cleaning baths for metals.

The presence of alkali metal elements in wastes can cause real trouble during their treatment. As an example, they can damage refractories of the incineration kilns. It is possible to circumvent this problem by neutralising the alkali compounds with acid chemicals, by dilution with water or by solidification before land placement with cement. The solidification technology however has a drawback in that only pure water and washed aggregates can in principle be used to make a quality concrete (see the book <<Le Béton hydraulique >>, Jacques Baron, Raymond Sauterey, <<Les Liants minéraux >>Philippe Pichat, journal <<Technique Moderne >> n° 1, 2001, pages 23-31).

There are strict laws and regulations about land placement. In France, a waste must comply with regulation regarding the pH value of the leaching water, total soluble fraction and solid content in order to be admissible. It has however been observed that sodium hydroxyde NaOH submitted to such a solidification treatment with cement is not transformed into a material where the leaching water has a pH of less than 13.

The aim of the invention is thus to provide a process for the manufacture of a solid material starting from an alkali metal hydroxyde or one of its precursors in a solid material complying with the regulation and particularly the standard X 30417.

The solid material is to be complying with the regulation when:
leaching water has a pH less than 13;
the soluble fraction is less than 10%;
solid content is higher than 30%; and
metal and phenol concentrations are less than the specific thresholds.

The invention is based on the observation that an aqueous solution of metal alkali hydroxyde, a calcium salt and silica is transformed within some weeks into a solid material with very low solubility.

According to a first aspect, the invention provides a process for the manufacture of a solid material starting from a metal alkali hydroxyde or one of its precursors, comprising the step consisting of:
mixing the metal alkali hydroxyde or one of its precursors with a calcium compound and silica in the presence of water.

The metal alkali hydroxyde can be a lithium, sodium, potassium, rubidium, caesium or francium hydroxyde. Preferably it is sodium hydroxyde or potassium hydroxyde.

Under the term “precursors of metal alkali hydroxyde”are understood the compounds able to form metal alkali hydroxydes in aqueous solution. As examples of a precursor may be cited the carbonates and oxydes. Preferably, the precursor is a metal alkali carbonate.

Preferably, the metal alkali hydroxyde is present in form of a concentrated aqueous solution, in particular 1 N or better 10 N, up to saturation. It can also be in a sursaturated solution or even in form of a dispersion.

The preferred calcium compound is calcium carbonate. It however can be substituted or mixed with another calcium compound such as chloride, bromide, sulfate, nitrate or phosphate. According to a particular embodiment the calcium compound and/or the silica are residues.

It is preferable for the calcium compound is to be added as a powder. Preferably, the calcium compound is made of particles with a particle size of 100% less than 1.000 μm, even more preferably less than 500 μm and especially preferently less than 100 μm. Chalk is especially appropriate.

The silica is also preferably a powder. Ideally, the silica has a particle size of 100% less than 1.000 μm, more preferably less than 500 μm and in particular less than 100 μm. Preferably, the silica is present in a form different from quartz, which has a poor reactivity.

It can however be under another form allowing optimisation of the surface contact with the solution and thereby of the reactivity, a colloidal solution for example.

According to a specific embodiment the calcium compound and the silica are added as a silico calcic compound such a silico calcic sand, fly ashes, bottom ash or a slag.

The process can be operated either in a continuous mode or in a batch.

The process operation is very simple and includes the step of contacting the solution of metal alkali hydroxyde with the calcium compound and silica.

The ratio of the reactives can vary largely within a broad range. For information only, addition of the reagents within molar ratio of 0.1 to 10 with respect to the metal alkali hydroxyde or its precursor is adapted to give satisfactory results.

Preferably, 0.1 to 5 moles of calcium compound per mole of metal alkali hydroxyde or its precursor. In the same way, 0.1 to 5 moles of silica are added per mole of metal alkali hydroxyde or its precursor.

Preferably the various ingredients are mixed for about 5 minutes.

The calcium compound and silica oxide can be added to the metal alkali hydroxyde simultaneously or individually.

According to particular embodiment of the process, the calcium compound and the silica are dispersed separately in the alcali metal hydroxyde or its precursor before mixing the two dispersions.

The dispersions may or may not be mixed immediately after their preparation. This embodiment offers the advantage of reducing the quantities of reagents necessary in order to solidify the metal alkali hydroxyde or its precursor, all other conditions being identical.

In practice, the quantity of reagents necessary to solidify 100 parts in weight of NaOH 10 N can be reduced from 39.4 parts in weight of CaCO₃ (powder<600 μm) and 80 parts of SiO₂ to 27 parts in weight CaCO₃ (powder<600 μm) and 70 parts of SiO₂ respectively.

It is supposed that there is formation of Tobermorite on one hand and of Pirsonnite-Gay—Lussite on the other hand.

A thickening of the dispersions of calcium compound and silica are observed even when they are kept without any agitation at room temperature. However, the reaction can be accelerated by an agitation and by increasing the temperature.

The viscosity of the mixture increases rapidly. According to the concentration of alkali metal hydroxyde and the reagents, the product is obtained in form of aggregates, putty, paste or a grout.

Generally, it is not necessary to provide any additional thermal energy. The reaction generally takes place over some days or weeks at room temperature.

The obtained product can then be transformed into a monolithic material. It can then be put in shape by pouring, pomping, compressing or vibro compacting.

The process according to the invention is particularly surprising because sodium hydroxyde has a high solubility (420 gr/liter) as almost all sodium compounds and is solidified by a calcium salt and silica, which are slightly soluble in water and not very reactive.

The process according to the invention is simple and very economical to operate since it needs only low cost reactives originating preferably from quarries. Their production needs a little energy and does not pollute. According to the preferred embodiment, the calcium compound is obtained from residues.

Therefore, the process does not need any thermal energy, any costly or sophisticated equipments and does not represent any specific danger to personnel and the environment.

Furthermore, the process according to the invention does not cause gaseous or liquid discharges in the environment and is, therefore, ecologically clean.

The process according to the invention can also be used to coat other residues in order to isolate them physically and chemically. This variant is particularly interesting for instance for trapping elements capable of leaching.

Indeed, the solution in the course of solidification contains silico-calcic hydrates which have usually a high specific area, about several hundred of m²/g. This allows the capture of elements inclined to leach out of the wastes in the solidified product.

According to another aspect, the invention provides a process for the storage of solid wastes insoluble in water comprising the following steps:
mixing of a alkali metal hydroxyde or one of its precursors, a calcium compound and silica in the presence of water;
immersion of the wastes in the said mixture;
physical and chemical isolation of the said wastes in the solidificated said mixture; and
transformation of the solid material obtained into a monolithic product.

The wastes can be of any type. Preferably, they are pieces of graphite. Particularly preferred wastes are toxic and/or radioactive wastes according to the laws and regulations.

Preferably, the solid material obtained conforms with the French regulatory rules relative to land placement of wastes.

Particularly, the solid material presents preferably:
a leaching water having a pH of less 13;
a soluble fraction less than 10%;
a solid content higher than 30%; and
heavy metals and carbon concentration lower than the specific thresholds.

The invention, according to another aspect, also aims to a solid material obtainable by the above described process. The speed of solidification of the product is high enough to allow for its use or storage is immediately after its manufacture. The obtained product may thus be stored directly.

The solid material may then be used in a building site to make works such as grouts, slabs, roads or to be used to fill cavities or in precast plant for example. It can also be put in a storage facility for ultimate wastes or a center of technical burying.

According to a last aspect, the invention aims at the use of the solidified products obtained for the construction of buildings and public works and for the storage of solid wastes.

The following examples are given to illustrate the invention, but are not limitative in anyway.

### EXAMPLES

### Example 1

To 1.000 kg of a solution of sodium hydroxyde 16.7 N are added 700 kg of calcium chloride in form of industrial residue and 640 kg of silica coming from a quarry with a particle size of 100% less than 1.000 μm. At 28 days of age, a solid material is obtained. It is subjected during 24 hours to the leaching test according to the X 30417 standard. The pH of the solution is less than 13, the soluble fraction is less than 10% and the solids content is higher than 35% in weight.

### Example 2

To 1.000 kg of solution of sodium hydroxyde 10 N are added 1.100 kg of calcium carbonate powder with a particle size of 100% less than 500 μm and 623 kg of silica in form of industrial residue, the particle size of which is 100% less than 1.500 microns. At 28 days of age, a solid is obtained. It is subjected over 24 hours to the leaching test according to the X 31212 standard. The pH of the solution is less than 13, the soluble fraction is less than 10, the solid content is more than 35% in weight.

### Example 3

To 1.000 kg of a solution of sodium hydroxyde 10 N are added 990 kg of calcium carbonate powder, the particles size of which being 100 % less than 500 microns, 110 kg of calcium chloride and 625 kg of silica, an industrial residue with a particle size of 100% less than 500 microns. At 28 days of age, a solid material is obtained. It is subjected over 24 hours to the leaching test according to the X 31212 standard. The pH of the solution is less than 13, the soluble fraction is less than 10, the solid content is more than 35% in weight.

### Example 4

Graphite cylinders having a diameter of 135 mm, a height of 600 mm and a weight of 11 kg are immersed into a fresh solution prepared according to example 2. This matrix confers by solidifying a physical and chemical insulation and a trapping in situ of the pollutants which can be contained in the graphite, for example radioactive isotopes.

### Example 5

100 kg of NaOH (in form of a solution 10 N), are mixed with 33 kg of silica and left in contact for six days. Then 35 kg of calcium carbonate extracted from a quarry with a particle size of 100% less than 600 microns are added. A material complying with the X 30417 standard is obtained, with in total 68 kg of reagents for 100 kg of metal alkali hydroxyde.

### Example 6

100 kg of NaOH (in form of a solution 10 N) are mixed with 27 kg of calcium carbonate extracted from a quarry with a particle size of 100% less than 600 microns and left in contact for three days. 35 kg of silica are then added. A material complying with the X 30417 standard is obtained with 62 kg of reagents for 100 kg of metal alkali hydroxyde.

### Example 7

100 kg of NaOH (in form of a solution 10 N) are mixed with 27 kg of calcium carbonate and left in contact for one day. In a second appropriate container, 100 kg of NaOH (in form of a 10 N solution) are mixed with 24 kg of silica and left in contact for three days. A material complying with the X 30417 standard is obtained with 51 kg of reagents for 100 kg of metal alkali hydroxyde.

1. A process for the storage of wastes, comprising the following steps:
mixing of an hydroxyde with a calcium compound and silica in presence of water;
immersion of wastes in the said mixture;
physical and chemical insulation of the said wastes in the said solidified mixture; and
transformation of the solid material obtained into a monolithic product.

2. Process according to the claim 1, wherein the calcium compound and silica are dispersed separately in the alkali metal hydroxyde or its precursor before mixing the two dispersions.

3. Process according to claim 1, wherein 0.1 to 5 moles of calcium compound are added per mole of alkali metal hydroxyde or its precursor.

4. Process according to claim 1, wherein 0.1 to 5 moles of silica are added per mole of alkali metal hydroxyde or its precursor.

5. Process according to claim 1, wherein the solid material has a leaching water having a pH of less than 13.

6. Process according to claim 1, wherein the solid material has a soluble fraction of less than 10%.

7. Process according to claim 1 , wherein the solid material has a solid contents higher than 30%.

8. Process of placement according to claim 1, wherein the said wastes are pieces of graphite.

9. Monolithic product obtainable by the process according to the claim 1.

10. Use of the monolithic product according to the claim 9 for the construction of building and public works and for the storage of solid wastes.
